(19) United States
(12) Patent Application Publication
(10) Pub. No.: US 2012/0100763 A1
(43) Pub. Date: Apr. 26, 2012

(54) END FITTING OF AN ELECTRICAL PART AND METHOD FOR PRESSING AN END FITTING

(75) Inventor: Kai Steinfeld, Waiblingen (DE)

(73) Assignee: SIEMENS AKTIENGESELLSCHAFT, MUENCHEN (DE)

(21) Appl. No.: 13/381,553

(22) PCT Filed: Jun. 11, 2010
(86) PCT No.: PCT/EP2010/058246

§ 371 Date: Dec. 29, 2011

(30) Foreign Application Priority Data
Jun. 30, 2009 (DE) 10 2009 031 571.3

(51) Int. Cl. H01R 13/03; B23P 11/00; H01R 13/02; B23P 19/02

(52) U.S. Cl. 439/887; 29/281.3; 29/525; 439/884

(57) ABSTRACT

An end fitting of a surge arrester has a recess for receiving a rod, wherein the rod can be pressed inside the recess by applying an outer force to the end fitting. Furthermore, a corresponding device for pressing an end fitting and a method for pressing an end fitting are described. The end fitting contains a plurality of body edges delimited in an arc shape. Spaces between points on the body edge delimited in an arc shape and a center point of the recess are equidistant. Thus it is possible to exert a uniform force on all sides on a recess and thus provide an even deformation on all sides of the recess during pressing. As a result, accordingly pressed items, for example rods within the recess, are pressed within the recess on all sides.

The invention relates to an end fitting of an electrical part, in particular of a surge arrester, having a cutout for holding a bar, in which case the bar can be pressed within the cutout by application of external force to the end fitting. The invention furthermore relates to an apparatus and a method for pressing an end fitting of a surge arrester.

Electrical parts for high-voltage applications, in particular surge arresters, are composed of widely differing components and materials. This frequently results in the difficulty that metallic parts, in particular, have to be connected to further components of the electrical part. One suitable method for this purpose is the so-called pressing of the metallic part by application of external force to the metallic part for connection to another component composed of a different material. For example, in electrical engineering, electrical conductors and wires are connected to a suitable cable lug by pressing. Bars composed of glass-fiber-reinforced plastics are also used as connection pieces within a surge arrester.

During the pressing of the metallic components of the electrical part, these metallic parts generally have simple and rotationally symmetrical geometries, as a result of which it is easy to ensure that the metallic component of the electrical part is pressed. In the case of more complicated structures and arrangements of the metallic component of the electrical part—for example as a result of the so-called Käfigdesign® (cage design) for surge arresters—a plurality of annular bars which are arranged are connected to one another in an end fitting as a metallic part of the surge arrester, by pressing. In order to ensure that a plurality of bar elements are connected by pressing in this way to a metallic part of an electrical component, the metallic part is provided with a round external contour, which is designed to correspond to the internal contour of a corresponding press. For example, U.S. Pat. No. 5,757,604 describes an end fitting of a surge arrester, which has a cruciform shape in order that gases which are created in the event of a short circuit can be dissipated along these discrepancies from the cross-sectional contour on the outer wall of the surge arrester.

The previous method for pressing a metallic part of an electrical component is subject to the problem that the at least circular cutout in the mating piece to be pressed is not pressed on all sides. This is because force is not applied on all sides around the cutout because of the external press, as a result of which the cutouts which, by way of example, were previously circular assume an elliptical shape after pressing. A bar which has been pressed in this way, for example, within the circular cutout is therefore not pressed on all sides within the cutout in this case, but only at specific points on the elliptical shape of the cutout which is formed after pressing. This can result in stress peaks within the cutouts when loads are applied, which can lead to damage to the bars. The degree of pressing must therefore be based on these stress peaks, and the connection can be utilized only to a lower level than would be the case if pressed on all sides.

The object of the present invention is therefore to apply force on virtually all sides when pressing a metallic part of an electrical component within the cutout, thus ensuring that a corresponding mating piece is pressed on all sides within the cutout.

The object is achieved by an end fitting as claimed by the features of patent claim 1.

The object is likewise achieved by an apparatus for pressing an end fitting as claimed by the features of patent claim 9.

The object is furthermore achieved by a method for pressing an end fitting as claimed by the features of patent claim 13.

According to the invention, an end fitting of an electrical part, in particular of a surge arrester, is provided with a cutout for holding a bar, with the cutout being surrounded by a body edge, which is bounded in the form of a curve, of the end fitting, with distances between points on the body edge which is bounded in the form of a curve and a center point of the cutout being equidistant. The provision of a body edge, which is bounded in the form of a curve, around the cutout ensures that, when external force is applied, the cutout is compressed by the application of force—at least in the corresponding segment of the body edge which is bounded in the form of a curve—and therefore that a bar which has been inserted within the cutout is pressed on all sides in this segment. This concept of equidistant intervals between points on the body edge which is bounded in the form of a curve and a center point of the cutout ensures that the cutout is pressed uniformly and on all sides when a standard material is used for the end fitting and force is applied in a standard manner to the body edge, which is bounded in the form of a curve, of the end fitting.

For the purposes of the definition, a cutout is any recess within the end fitting into which a second part to be pressed can be inserted. In particular, circular shapes or any other rotationally symmetrical shapes, for example a triangular shape or hexagonal shape, are cutouts for the purposes of the present invention.

In one advantageous refinement of the end fitting, a plurality of body edges which are bounded in the form of a curve are arranged equidistantly as an outer edge of the end fitting. In particular, a cruciform or star-shaped arrangement, with each body edge which is bounded in the form of a curve defining one segment of the cross or of the star, offers the advantage that the cutout can be arranged on all sides and rotationally symmetrically on the end fitting. This ensures that the end fitting is correspondingly pressed on all sides and rotationally symmetrically with corresponding parts, in particular bars. Furthermore, the stresses and forces within the bars are distributed uniformly over the end fitting.

It is considered to be advantageous to arrange curved contour lines between the body edges which are bounded in the form of a curve. Curved contour lines on the end fitting make it possible to avoid stress peaks during the pressing process between the body edges, which are bounded in the form of a curve, for application of external force to the end fitting. In the case of straight or pointed contour lines, there would be a risk of breaking within these structures, because these structures could lead to accumulation of stresses, and therefore to cracks within the end fitting.

Advantageously, the body edge which is bounded in the form of a curve has an angle range of at least 180° with respect to the center point of the cutout. In a situation when force is exerted on the cutout over an angle range of 180° with respect to the center point of the cutout, this ensures that the same force is applied, and therefore that the pressing is the same, in a large area of the cutout. The strength characteristics of the end fitting in the other angle range therefore ensure that virtually uniform force is exerted on the cutout on all sides, and therefore that a bar can be pressed uniformly and on all sides within the cutout.

In this case, advantageously, each body edge which is bounded in the form of a curve has a respectively associated cutout, thus allowing all of the cutouts which are located on an end fitting to be pressed uniformly. The cutout is advantageously circular. In order to ensure that the end fitting is pressed uniformly and rotationally symmetrically, the end fitting is designed such that a plurality of cutouts are at equal longitudinal and/or angular distance from a center point of the end fitting. When force is applied on all sides and uniformly to the entire end fitting, this therefore allows the cutouts which are located on the end fitting to be pressed on all sides and uniformly.

Advantageously, the end fitting is composed of an aluminum mixture, in particular an LY12 aluminum mixture. The characteristics of this aluminum mixture allow the end fitting to be pressed uniformly.

According to the invention, an apparatus is likewise provided for pressing an end fitting, in which case a pressing segment has a corresponding shape to at least one body edge, which is bounded in the form of a curve, of the end fitting. A corresponding shape of the pressing segment toward the body edge, which is bounded in the form of a curve, of the end fitting ensures that an external force is applied uniformly and on all sides to the body edge, which is bounded in the form of a curve, of the end fitting. This allows the cutout to be pressed uniformly and on all sides within the end fitting.

Advantageously, a plurality of pressing segments are arranged on all sides surrounding the end fitting, with the pressing segments exerting force on all sides on the end fitting and, via the body edges which are bounded in the form of a curve, on the cutout, thus leading to the cutout being pressed on all sides and uniformly.

One advantageous refinement of the apparatus provides that a pressing edge of the pressing segments virtually corresponds to the contour of the corresponding body edge, which is bounded in the form of a curve, and the curved contour line of the end fitting. If the external contours of the end fitting and of the pressing segments of the apparatus for pressing the end fitting have virtually the same contours, this ensures that direct force coupling, and therefore that force is applied to the end fitting, is guaranteed by the pressing segments.

Advantageously, the pressing segments are formed as circular segments, in which case the force can be applied directly to the pressing segments and therefore to the end fitting via a circular press. A press whose radius decreases allows a pressing effect to be exerted on all sides on the pressing segments and, because of an immediate contour of the pressing segments with the external contour of the end fitting, allows force to be exerted directly on the end fitting, and therefore on the cutout.

According to the invention, a method is likewise provided for pressing an end fitting of a surge arrester having a cutout, with a bar being pressed within the cutout and with the end fitting being arranged in a press with a body edge, which is bounded in the form of a curve, around the cutout, with equal distances between points on the body edge which is bounded in the form of a curve and a center point of the cutout. The press has pressing segments which have a contour which corresponds to the body edge which is bounded in the form of a curve and which are pressed onto the pressing segments and onto the end fitting because of the pressing effect of the press. The end fitting is advantageously pressed by radial movement of the pressing segments relative to one another, in particular within a circular press. In one advantageous refinement of the method, the pressing segments are in the form of circular segments and are used in a press, which reduces the circle circumference, for pressing of the end fitting. In this case, a plurality of bars are advantageously pressed into respectively associated cutouts.

When using identical end fittings for an inner part of a surge arrester, it is advantageous for the first end fitting to be removed from the press after the pressing of the first end fitting with first end parts of the bars. The second end fitting is then inserted into the press or the pressing segments and is then pressed with the second+end parts of the bars. In a possible intermediate step, further components of the electrical part, in particular of the surge arrester, for example varistor elements, can be introduced within the bars, and can be fixed by the pressing of the second end fitting.

Further advantageous refinements will become evident from the dependent claims. The subject matter of the invention will be explained in an exemplary form by means of the following figures, in which:

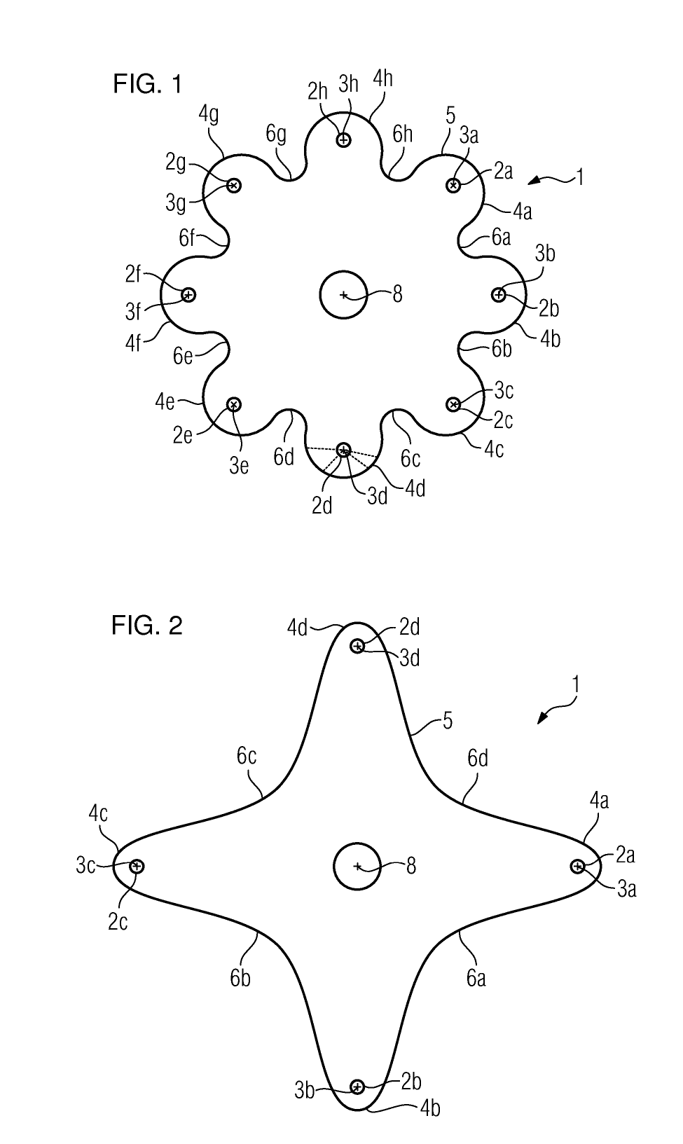

FIG. 1 shows a plan view of a star-shaped end fitting;

FIG. 2 shows a plan view of a cruciform end fitting;

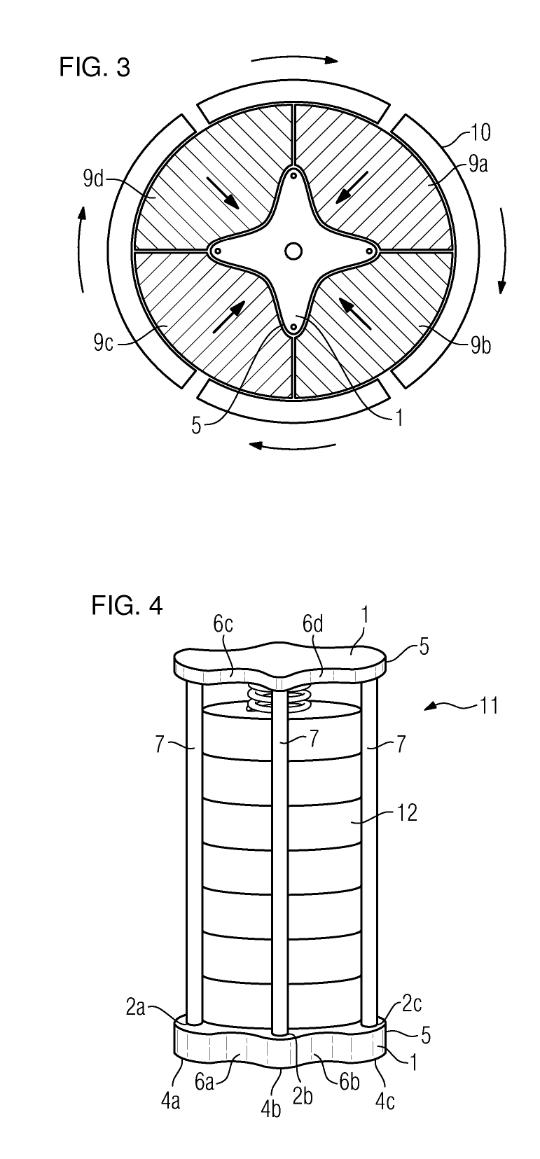

FIG. 3 shows a plan view of a star-shaped end fitting within four pressing segments;

FIG. 4 shows a perspective view of a surge arrester with two end fittings.

FIG. 1 shows a plan view of a star-shaped end fitting 1 with eight body edges 4a to 4h which are bounded in the form of a curve and have respective cutouts 2a to 2h and respective center points of the cutouts 3a to 3h. Furthermore, the curved contour lines 6a to 6h are shown in the star-shaped end fitting 1, thus allowing bars 7 (not illustrated) to be pressed uniformly when the same force is applied on all sides to the outer body edge 5 of the end fitting. The body edges 4a to 4h which are bounded in the form of a curve are distributed equidistantly and uniformly on the outer edge of the end fitting 1, with respect to a center point 8 of the end fitting 1.

FIG. 2 also shows an end fitting 1 in a cruciform shape with four curved body edges 4a to 4d. With respect to the respective center point of the cutouts 3a to 3d, the shape of the body edge which is bounded in the form of a curve is designed such that the distances between points on the body edge which is bounded in the form of a curve and the center point of the respective cutout are equal.

FIG. 3 shows a plan view of a cruciform end fitting 1, which is arranged within four pressing segments 9a to 9d. The pressing segments 9a to 9d have a contour which is in the form of a circle segment in places, with the internal contour of the pressing segments 9a to 9d corresponding to the external contour 5 of the end fitting 1. Force can be exerted on all sides on the pressing segments 9a to 9d, and therefore on the outer edge 5 of the end fitting 1, by means of a press 10 which allows force to be applied radially because of reducing circumferences of the press. The body edges 4a to 4h (not illustrated) which are bounded in the form of a curve ensure that force is exerted on all sides on the cutouts 2a to 2h, and therefore that the cutouts 2a to 2h are pressed uniformly and on all sides. With respect to the body edge 4d which is bounded in the form of a curve, FIG. 1 shows the distances between points on the body edge 4d, which is bounded in the form of a curve, with respect to the center point 3d of the cutout 2d, which, with reference to FIG. 3, leads to the respective cutout 2a to 2h being pressed on all sides.

FIG. 4 shows a perspective view of a surge arrester 11 having two end fittings 1, with the end fittings 1 being cruciform. Bars 7 are inserted into each of the cutouts 2a to 2d and are pressed by means of the apparatus for pressing. The bars 7 are advantageously formed from glass-fiber-reinforced plastics. Additional electrical elements, for example varistor elements 12 and spring elements, can be inserted within the bars 7. A surge arrester 11 in this form can be pressed such that the first end fitting 1 together with the bars 7 is first of all pressed within a press 10 (not illustrated), and the first end fitting 1 is then removed, together with the pressed bars 7, from the press 10. Further elements, for example varistor elements 12, can then be arranged within the bars 7. The second end fitting 7 can then be placed on the bars 7, if required can be stressed axially, and can then be pressed radially by means of the press 10.

The present invention allows contour pressing of an end fitting 1 to be carried out in order to ensure that force is applied on all sides and uniformly to the cutouts 2a to 2h. The application of force on all sides to the cutouts 2a to 2h ensures corresponding uniform deformation of the cutout 2a to 2h around the pressed part, in particular a bar 7. When a structure in the form of a cage and composed of glass-fiber-reinforced plastic bars 7 is connected to an end fitting 1, the distribution of the introduction of force and the deformation of the cutouts 2a to 2h around the bars 7 is no longer elliptical, as previously in the prior art, but is virtually circular. This allows the pressure connection to be utilized to a greater extent, and the forces transmitted to the cutout 2a to 2h to be increased. An additional advantage of the present invention is that, in contrast to a circular end fitting 1, the reduced size of a star-shaped or cruciform shape of the end fitting 1 also makes it possible to save material.

### LIST OF REFERENCE SYMBOLS

End fitting
2a to 2h Cutout
3a to 3h Center point of the cutout 2a to 2h
4a to 4h Body edge which is bounded in the form of a curve
5 Outer edge
6a to 6h Curved contour line
7 Bar
8 Center point of the end fitting 1
9a to 9d Pressing segment
10 Press
11 Surge arrester
12 Varistor elements

1-18. (canceled)

19. An end fitting of an electrical part, the end fitting comprising:
an end fitting body having a cutout formed therein for holding a rod, the rod can be pressed within said cutout by application of external force to said end fitting body, said end fitting body having a body edge surrounding said cutout, said body edge being bounded in a form of a curve, and distances between points on said body edge being bounded in the form of said curve and a center point of said cutout being equidistant.

20. The end fitting according to claim 19, wherein said body edge is one of a plurality of body edges which are bounded in a form of a curve and are disposed equidistantly as an outer edge of said end fitting body.

21. The end fitting according to claim 20, wherein said end fitting body has curved contour lines disposed between said body edges which are bounded in the form of said curve.

22. The end fitting according to claim 19, wherein said body edge which is bounded in the form of said curve has an angle range of at least 180° with respect to said center point of said cutout.

23. The end fitting according to claim 20, wherein each of said body edges which is bounded in the form of said curve has a respectively associated said cutout.

24. The end fitting according to claim 19, wherein said cutout is circularly shaped.

25. The end fitting according to claim 23, wherein said end fitting body has a central point and said plurality of cutouts are equidistant from said central point.

26. The end fitting according to claim 19, wherein said end fitting body is formed from an aluminum mixture.

27. The end fitting according to claim 19, wherein said end fitting body is formed from an LY12 aluminum mixture.

28. An apparatus for pressing an end fitting having a cutout formed therein, the apparatus comprising:
a pressing segment having a shape corresponding to at least one body edge of the end fitting, the body edge being in a form of a curve.

29. The apparatus according to claim 28, wherein said pressing segment is one of a plurality of pressing segments surround the end fitting on all sides, on which a force can be exerted.

30. The apparatus according to claim 29, wherein said pressing segments have a pressing edge which corresponds to a contour of the corresponding body edge and to a curved contour line of the end fitting.

31. The apparatus according to claim 29, wherein said pressing segments are formed from circular segments, in which case a force can be applied to said pressing segments via a circular press.

32. A method for pressing an end fitting of an electrical part having a cutout formed therein, with a rod being pressed within the cutout, which comprises the steps of:
inserting the rod into the cutout;
disposing the end fitting having a body edge bounded in a form of a curve around the cutout, with distances between points on the body edge bounded in the form of the curve and a center point of the cutout being equidistant, in a press, with the press having pressing segments with contours which correspond to the body edge bounded in the form of the curve; and
pressing the end fitting by means of the pressing segments.

33. The method according to claim 32, which further comprises pressing the end fitting by radial movement of the pressing segments relative to one another.

34. The method according to claim 32, which further comprises forming the pressing segments in a form of circular segments and using the pressing segments with the press, which reduces a circle circumference, for pressing of the end fitting.

35. The method according to claim 32, which further comprises compressing a plurality of rods in respectively associated cutouts.

36. The method according to claim 32, which further comprises that after the pressing of a first end fitting with first end parts of the rods, removing the first end fitting from the press, and pressing second end parts of the rods with a second end fitting as an inner part of a surge arrester.

37. The method according to claim 32, which further comprises:
providing an apparatus for pressing the end fitting, the apparatus containing the pressing segments having a corresponding shape to at least one body edge, which is bounded in the form of the curve; and
using the apparatus for pressing the end fitting.
